(19) United States
(12) Patent Application Publication
(10) Pub. No.: US 2003/0004934 A1
(43) Pub. Date: Jan. 2, 2003

(54) Creating and managing portable user preferences for personalizion of media consumption from device to device

(76) Inventor: Richard Qian, Camas, WA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/895,431

(22) Filed: Jun. 29, 2001

(51) Int. Cl. G06F 7/00

(52) U.S. Cl. 707/3

(57) ABSTRACT

A method and apparatus are provided for creating and managing portable user preferences for personalized media consumption. According to one embodiment of the present invention, a set of user information is captured and stored on a portable medium, such as a smart card, compatible with various media devices. Such use of a portable medium makes the information accessible to multiple devices. Finally, the portable medium may used to tailor user preferences according to the device chosen by the user, and may be dynamically updated as user preferences change.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

This invention generally relates to the field of personalized media, and more specifically to dynamically updating user preferences and transporting such preferences from one entertainment device to another.

### BACKGROUND OF THE INVENTION

Setting user preferences on an electronic device is nothing new. There are several ways to update and store user preferences on a given device, and the devices are becoming increasingly smart and easy to use. However, the methods and devices available today are not mature enough to dynamically update user preferences. Additionally, the preference settings are not from device to device.

For instance, a user's favorite television (TV) network or channel settings cannot be transferred between two or more television sets or set-top boxes. Similarly, a user's preferences or favorite settings for web browsing or MP3 music selection may not be transferred when the user switches devices or even the program for surfing the web. Moreover, the methods and devices available today do not dynamically update user preferences, and therefore, require manual updating.

An example of a user preference-setting device is TIVO. TIVO uses a centralized system to collect information on users and updates such information from time to time. However, TIVO fails to recognize individual users, and instead, maintains information on a household-basis. Further, the information maintained by TIVO is not portable from device to device, and is only applicable to TIVO, and used for marketing purposes.

To obtain portability, typically a card can be used as a portable media. Cards with magnetic tapes, however, only hold limited information. Microprocessor-embedded smart cards can be programmed and personalized with users' information. However, the smart cards available today are also limited in at least the following three ways: (1) information on a smart card is limited to what the issuer wants to input; (2) the information is maintained and updated by the issuer; and (3) accessibility is limited to one type of device, such as an ATM, selected by the issuer, and therefore, the smart card is not portable.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1 is a block diagram of a typical computer system upon which one embodiment of the present invention may be implemented;

FIG. 2 is a block diagram illustrating an exemplary network upon which the present invention may be implemented;

FIG. 3 is a block diagram illustrating an overview of a process for communicating user preferences using a smart card, according to one embodiment of the present invention;

FIGS. 4a and 4b illustrate components of a personalized media consumption system, according to one embodiment of the present invention;

FIG. 5 a flow diagram illustrating personalized media consumption system processing, according to one embodiment of the present invention;

FIG. 6 is a block diagram illustrating components of a personalized media consumption system including integration of data, according to one embodiment of the present invention;

FIG. 7 is a flow diagram illustrating a process of personalizing and integrating user information in a media consumption system, according to one embodiment of the present invention.

### DETAILED DESCRIPTION

A method and apparatus are described for creating and managing portable user preferences for personalized media consumption. Broadly stated, embodiments of the present invention allow user preferences to be dynamically updated for personalized media, and support portability from device to device.

According to one embodiment of the present invention, a set of user information is captured and stored on a portable medium, such as a smart card, compatible with various media devices. Such use of a portable medium makes the information accessible to multiple devices. Further, the portable medium may be used to tailor user preferences according to the device chosen by the user, and may be dynamically updated as user preferences change.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps, which will be described below. The steps of the present invention may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

The present invention may be provided as a computer program product, which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

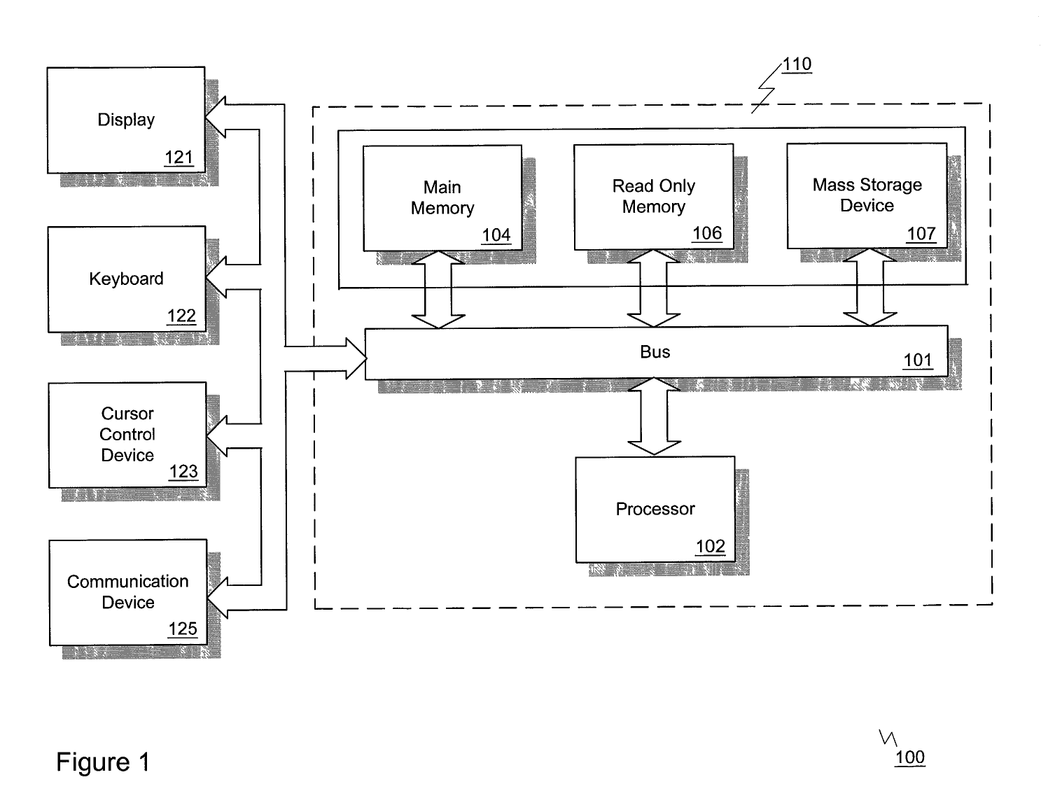

FIG. 1 is a block diagram of a typical computer system upon which one embodiment of the present invention may be implemented. Computer system 100 comprises a bus or other communication means 101 for communicating information, and a processing means such as processor 102 coupled with bus 101 for processing information. Computer system 100 further comprises a random access memory (RAM) or other dynamic storage device 104 (referred to as main memory), coupled to bus 101 for storing information and instructions to be executed by processor 102. Main memory 104 also may be used for storing temporary variables or other intermediate information during execution of instructions by processor 102. Computer system 100 also comprises a read only memory (ROM) and/or other static storage device 106 coupled to bus 101 for storing static information and instructions for processor 102.

A data storage device 107 such as a magnetic disk or optical disc and its corresponding drive may also be coupled to computer system 100 for storing information and instructions. Computer system 100 can also be coupled via bus 101 to a display device 121, such as a cathode ray tube (CRT) or Liquid Crystal Display (LCD), for displaying information to an end user. Typically, an alphanumeric input device 122, including alphanumeric and other keys, may be coupled to bus 101 for communicating information and/or command selections to processor 102. Another type of user input device is cursor control 123, such as a mouse, a trackball, or cursor direction keys for communicating direction information and command selections to processor 102 and for controlling cursor movement on display 121.

A communication device 125 is also coupled to bus 101. The communication device 125 may include a modem, a network interface card, or other well-known interface devices, such as those used for coupling to Ethernet, token ring, or other types of physical attachment for purposes of providing a communication link to support a local or wide area network, for example. In this manner, the computer system 100 may be coupled to a number of clients and/or servers via a conventional network infrastructure, such as a company's Intranet and/or the Internet, for example.

It is appreciated that a lesser or more equipped computer system than the example described above may be desirable for certain implementations. Therefore, the configuration of computer system 100 will vary from implementation to implementation depending upon numerous factors, such as price constraints, performance requirements, technological improvements, and/or other circumstances.

It should be noted that, while the steps described herein may be performed under the control of a programmed processor, such as processor 102, in alternative embodiments, the steps may be fully or partially implemented by any programmable or hard-coded logic, such as Field Programmable Gate Arrays (FPGAs), TTL logic, or Application Specific Integrated Circuits (ASICs), for example. Additionally, the method of the present invention may be performed by any combination of programmed general-purpose computer components and/or custom hardware components. Therefore, nothing disclosed herein should be construed as limiting the present invention to a particular embodiment wherein the recited steps are performed by a specific combination of hardware components.

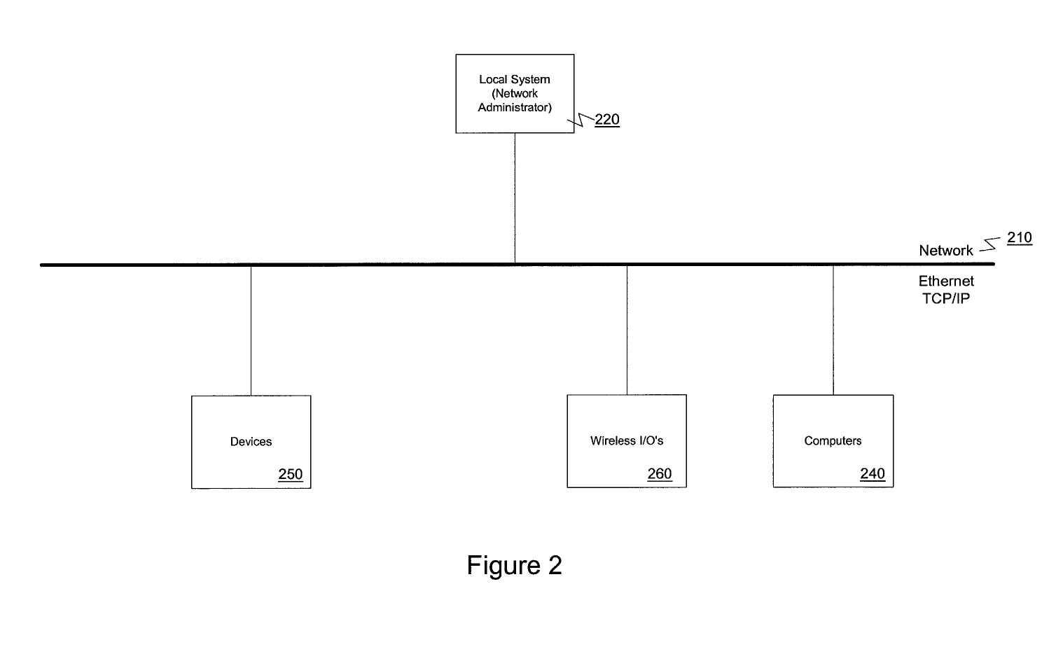

FIG. 2 is a block diagram illustrating an exemplary network upon which the present invention may be implemented. In this example, an Ethernet network 210 is shown. Such a network may utilize Transmission Control Protocol/Internet Protocol (TCP/IP). Of course, many other types of networks and protocols are available and are commonly used. However, for illustrative purposes, Ethernet and TCP/IP will be referred to herein.

Connected to this network 210 are computers 220, 240, devices 250, and wireless Input/Output (I/O) devices 260. The computers 220, 240 may include a network administrator terminal 220. A human operator could use this network administrator terminal 220 to monitor and maintain the network. The devices 250 may include network attached storage devices or other types of non-terminal devices or devices for the users to use that are compatible with smart cards. The wireless I/O devices 260 may include remote controls helping certain devices communicate with the system. The number and arrangement of this equipment may vary depending on the application.

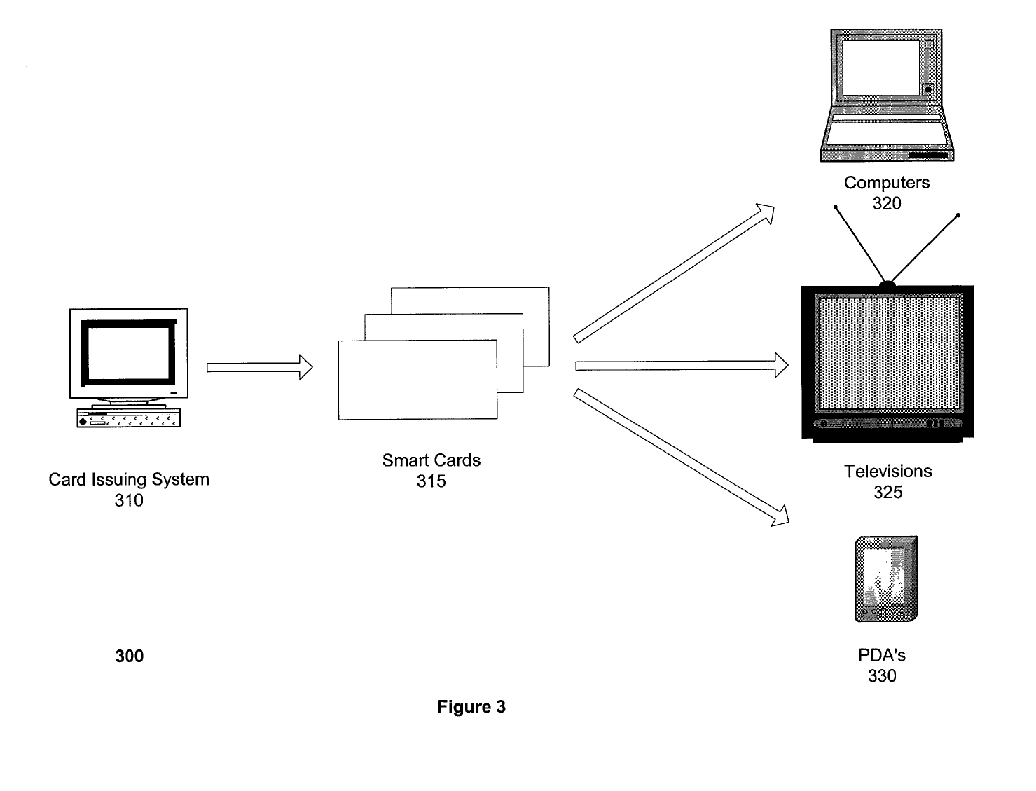

FIG. 3 is a block diagram illustrating an overview of a process for communicating user preferences using a smart card, according to one embodiment of the present invention. As illustrated, the card issuing system (issuer) 310 issues smart cards 315 to users. A user may use a smart card 315 with any of the compatible devices, such as computers 320, television sets 325, and PDAs 330. The smart cards available today typically only include user demographic and preference information, as tailored by the issuer, for use with only one designated device, such as an ATM. Thus, using the smarts cards available today, if any of the user information or preferences needs to be updated, a user would have to request the issuer to re-configure the smart card or issue a new smart card containing the updated information. Nevertheless, the smart card would remain compatible with only one device.

According to one embodiment of the present invention, the issuer 310 issues a smart card 315 with basic user demographic and preference information and user history templates compatible with multiple devices 320-330. A user may insert the smart card 315 in any of the compatible devices 320-330 of his or her choice. The user history templates, according to one embodiment of the present invention, are compatible with multiple corresponding devices 320-330, and can be used to store and update user preferences. The user may choose to manually update user preferences using any one of the devices 320-330 or let the smart card 315 or devices 320-330 detect user patterns and update user preferences automatically based on the detected pattern.

For example, a user inserts the smart card into a slot in a television set 325. Upon inserting the smart card 315, the system 300 identifies the user using the identification information (such as userid/password) assigned by the issuer 310. Upon user identification, user preferences are identified, and are translated into the format recognized by the device 325. Similarly, the smart card 315 identifies the device 325 and may communicate with the issuer 310, if necessary. Upon identifying the device 325, the smart card 315 generates a template to compile, maintain, and store user history, and automatically update user preferences based on the criteria initially set by the user and/or issuer 310. The criteria may track for information such as how many times a television program was watched in a given time period. In addition to the smart card automatically updating user preferences, the user may also manually update user preferences using the device 325. Further, the user may use the same smart card 315 with a different device, such as a computer 320.

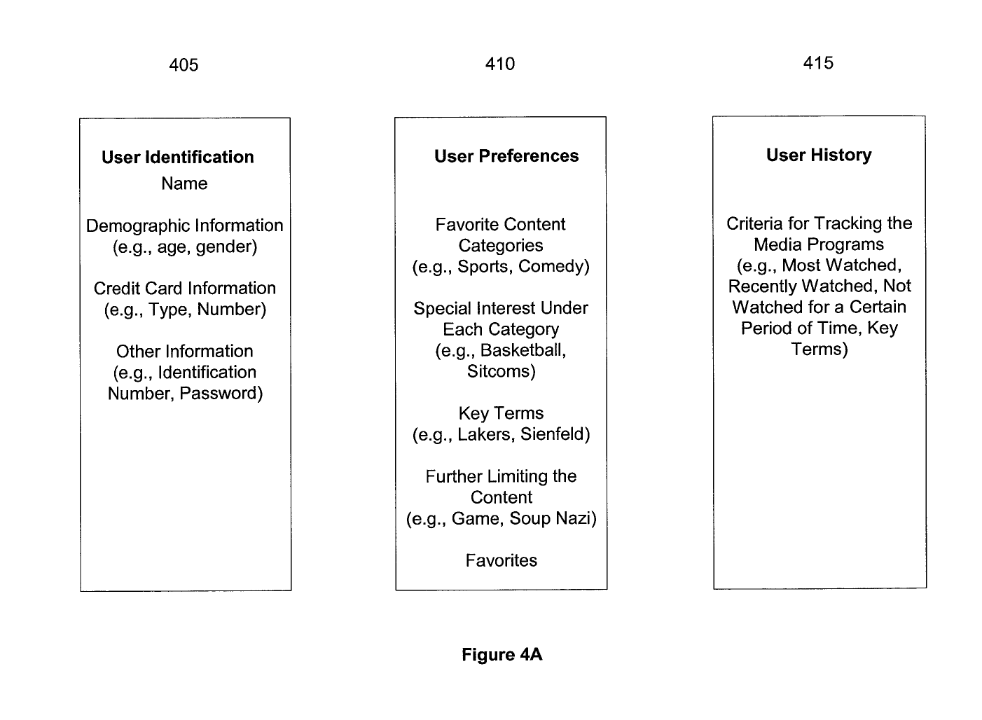

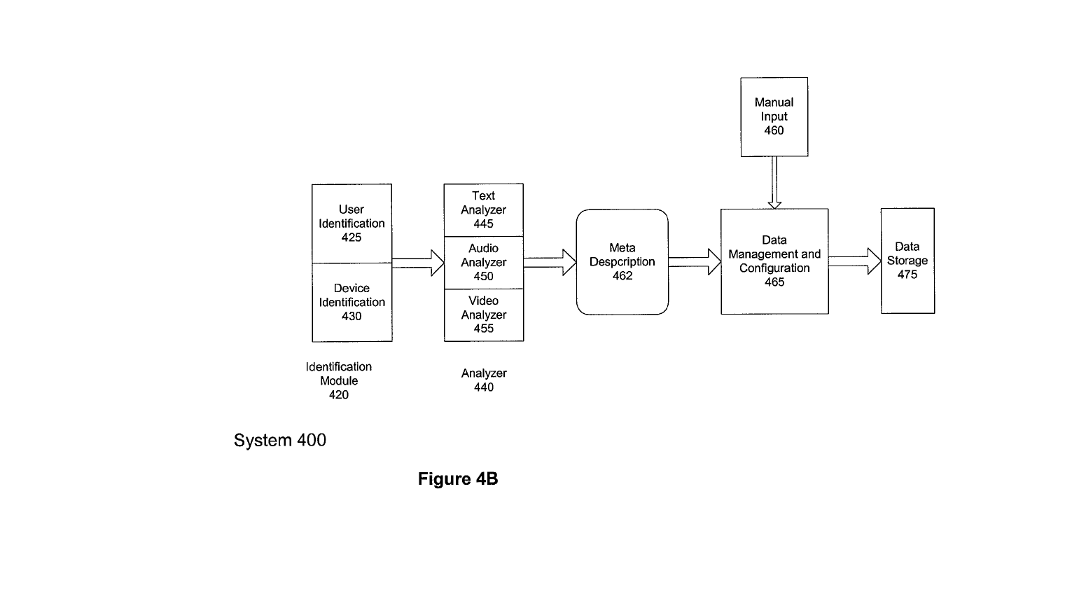

FIGS. 4A and 4B illustrate components of a personalized media consumption system, according to one embodiment of the present invention. FIG. 4A illustrates three templates 405-415 residing within the system the system 400, according to one embodiment of the present invention. An issuer may input user identification information 405 and user preferences 410 in a smart card at the time of issuance. The system 400 may retrieve an identification template 405 from a template database for obtaining the user information 405. Similarly, the system 400 may obtain a user preference template 410 corresponding to the device chosen by the user from the template database for indentifying user preferences 410 for the device chosen. Further, a blank user history template my reside with the system, however it is typically populated 415 only after the smart card is used at least once. Upon activating the smart card into a device, such as television, the identification module 420 is activated.

In the example illustrated in FIG. 4B, the identification module 420 performs two forms of identification. First, the user is identified 425 based on user identification, such as userid or password. Then, the system 400 identifies the device 430 in order to conform to the requirements of the device 325. For example, an identification template 405 may be retrieved from template database corresponding to the device chosen by the user.

The templates may be obtained from and stored in a variety of sources, such as the issuer, the smart card, or the device. For instance, the template database may reside with the issuer, and the issuer may provide the applicable templates as they are needed. The smart card may also contain a set of templates, which may be retrieved as they are needed. Further, a device may be configured to store corresponding templates for retrieval and future use. The system may have any combination of the issuer, the smart card, the device, or any other source or database for storing and retrieving templates. For example, the user may retrieve a template from the issuer or smart card, and at anytime after that may choose to save the template on the device for retrieving the saved information in the future. The user may choose to save only a copy of the template on the device and keep the original on the smart card (or vice versa) for portability. The analyzer 440 then works to analyze the data, such as television programming, to generate usage history 415.

The analyzer 440, based on the retrieved template, analyzes the behavior pattern of the user in order to automatically update user preferences 410 for future use. In the embodiment depicted, the analyzer 440 comprises three components, a text analyzer 445, an audio analyzer 450, and a video analyzer 455, where either one or any combination of the components may be used. The text analyzer 445 analyzes text, such as closed caption information, of a program to determine user patterns based on the criteria set forth in user preferences 410 either by the user or by the issuer. The audio analyzer 450 analyzes audio information associated with a program searching for key words, phrases, and categories defined in the criteria set forth in the user preferences 410. Finally, the video analyzer 455 analyzes the sequence of motions in a program in order to determine the category of the program as defined in user preferences. The outcome of the analyzer 440 is a meta description 462 about the semantic meaning of contents that in turn is fed into a data management and configuration module 465 along with any user manual input 460.

As illustrated, as an example, in user preferences 410, the user likes watching sports, but limits his interest to watching only the Los Angeles Lakers basketball games. Let us suppose that the user history 415 sets the criteria according to which watching a program three times a week is defined as a most watched program, while a program currently in the user preferences but not watched for three weeks is categorized as the least watched program. For example, the user in this case watches the Portland Trailblazers games, of which only one was against the Lakers, three times in one week. Following that week, the user stops watching the Lakers for three weeks. According to one embodiment of the present invention, the Trailblazers will be added to user preferences 410 at the end of the week in which the user watched the Trailblazers three times. In other words, user preferences 410 will be updated to have both the Lakers and Trailblazers listed. However, three weeks later, if this pattern continued, the Lakers would be dropped from user preferences 410 as one of the least watched programs.

In the example set forth above, according to one embodiment of the present invention, the text analyzer 445 first analyzes closed caption information, if available, noting the key terms such as Lakers, Trailblazers, dunk, assist. The audio analyzer 450 simultaneously searches for key terms in the audio of the program to determine with what frequency (e.g., how many times a week) the program is being watched. The video analyzer 455, meanwhile, analyzes motion activity of the program to determine the type of programming. For instance, a basketball game has a left-right/right-left motion as opposed to basketball news/commentary. A combination of the video analyzer 455, the ext analyzer 445, and the audio analyzer 450 provides enough information to determine specifically what program the user is watching.

The database management and configuration module 465 then receives the analyzed data (meta description) from the analyzer 440 and any data that the user inputs manually 460. Once collected, the data is managed and configured. For instance, the database management and configuration module 465 parses the metadata, which may be expressed using different standards or formats (e.g., RDF, MPEG-7, TV-AnyTime). Further, the database management and configuration module 465 configures the data by first querying for any conflicts between the data received from the analyzer 440, and received via the user's manual input 460. According to one embodiment, in the event that there is a conflict between the two sets of data, the data entered by the user 460 outweighs the analyzed data. For instance, if the analyzed data determines that the Lakers should be removed from user preferences 410, but the user, realizing that the Lakers will be removed from the list, reenters the term “Lakers,” the term will remain part of the user preference template 410. Based on such information, the system tracks user history 415 and dynamically updates user preferences 410, and stores it 475 for future use.

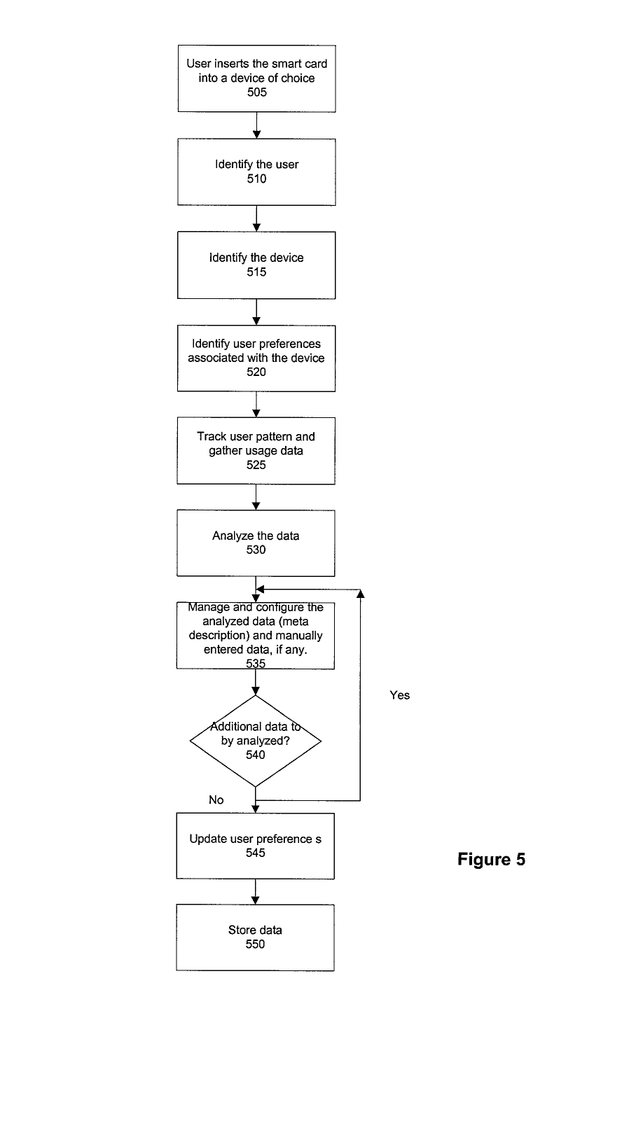

FIG. 5 a flow diagram illustrating personalized media consumption system processing, according to one embodiment of the present invention. First, the issuer issues a smart card to a user may be with initial information such as user identification information and user preferences. The user inserts the smart card into a device choosing from multiple media devices in processing block 505. The system first identifies the user in processing block 510, and then identifies the device in processing block 515. An identification template retrieved from a template database with the user and device information may be used for identification purposes. The system retrieves a user preference template corresponding to the chosen device from the template database. User preferences associated with the device are identified using the corresponding user preference template in processing block 520. A user history template is retrieved from a template database corresponding to the device chosen by the user. The template is used to track user pattern and gather usage data in processing block 525. As mentioned above, with reference to FIG. 4, that a template, including the user history template, may by stored in and retrieved from any combination of sources and databases including, but not limited to, the issuer, the smart card, and the device. The analyzer analyzes the data read, listened to, and/or viewed by the user using an analyzer comprising one or more of a text analyzer, an audio analyzer, and a video analyzer in processing block 530. The analyzed data (meta description) is transferred to the database management and configuration module 465 in processing block 535.

At decision block 540, the system determines whether the user manually entered any information. If no such information was entered, the analyzed data is parsed and configured in the database management and configuration module 465 having priority and importance over the analyzed data in processing block 535. The resulting data is then used to update user preferences at processing block 545. Finally, the data is stored for future reference in processing block 550. If the user elected to enter information, such information is transferred to data management and configuration module 465 in processing block 535 along with the analyzed data. The resulting data is then used to update user preferences in processing block 545. Finally, the data is stored for future reference in processing block 550.

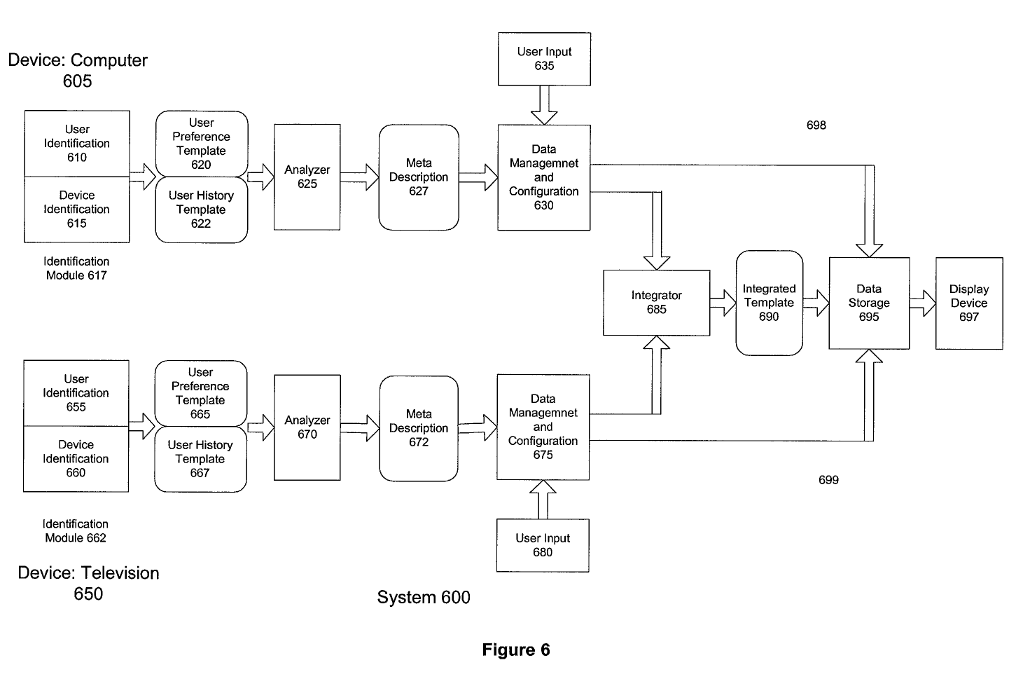

FIG. 6 is a block diagram illustrating components of a personalized media consumption system including integration of data, according to one embodiment of the present invention. As illustrated, for example, the user first accesses a computer 605 to access NBA.com to find out about the Lakers' performance against the Trailblazers during the first round of the NBA Playoffs 2000-01 using a smart card. The system 600 identifies and verifies the user 610 and identifies the device 615. The user reads the text and statistics detailing the performance of the Lakers. Once the device, the computer 605, is identified 615, a user preference template containing user preferences associated with the computer 605 is retrieved 620 for identifying the user preferences. Similarly, a user history template suited for tracking website usage history 622 is retrieved. The data transferred to or from the website is then analyzed 625 and the resulting meta description 627 is transferred to the database management and configuration module 630 along with the data manually entered by the user 635, if any. The combined data is then parsed and configured in the database management and configuration module 630.

The user then uses a different device, for example, a television set 650 to learn more about the Lakers' performance in the first round of the playoffs on NBC, which broadcasts an interview with the Lakers' coach, Phil Jackson. Following the same process, as described above, the meta description (or the analyzed data) is transferred to the database management and configuration module 675 along with data manually entered by the user 680, if any. The combined data is then parsed and configured in the database management and configuration module 675.

According to one embodiment of the present invention, the parsed and configured data is then transferred to the integration module 685 for integration. The data management and configuration module 630 receives the meta description and user data in different formats, such as MPEG-7, RDF, and TV-AnyTime, and parses the data using parsers for different formats, and then translates the data into a common descriptor. The common descriptor is used for the integration module 685 to recognize and process the data. The parsed data and all its associated content may be sent to the integration module 685 through an Application Programming Interface (API) or using an extensible markup language (XML). Further, the integration module 685 may include a content filter for filtering out unwanted or overlapping information or even when integrating the data. The integration module 685 may sort and/or prioritize the data for the user, based, for instance, on user preferences or criteria set forth by the user.

Using the Lakers' example, the data management and configuration module 630 may use a common descriptor, such as “Lakers”, and the website information and Phil Jackson's interview as content associated with the common descriptor “Lakers”. The integration module 685 then filters the unwanted or overlapping information, for example, general interview questions regarding Phil Jackson's career as a coach prior to joining the Lakers, which may not include any Lakers-related discussion, and therefore is classified as unwanted information. Finally, the filtered data may be sorted and prioritized, for instance, into a set of user-defined topics retrieved from the criteria set forth by the user or by tracking user history.

A separate multipurpose template 690 is retrieved for maintaining the integrated data, which is used to update user preferences, and is stored 695 for future use. According to one embodiment of the present invention, the user may choose to display 697 the integrated data on any of the compatible devices, such as computers, televisions (with/without a set-top box), kiosks/web terminals, PDAs, portable media players, cellular phones. For example, when the user accesses his set-top box or computer with broadband connection, among stories of other interests, he will see the Lakers' first round performance story containing the broadcast-quality television video highlights of the coach's interview seamlessly integrated with the summary of the website story.

According to one embodiment of the present invention, the integrated data may be accessed at anytime and from anywhere. For example, the data may be stored at a service center or cached by a local storage of the client device to achieve the timesharing functionality. The data may also be accessed using various devices, such as personal computers, PDAs, kiosks/web terminals, portable media players, televisions (with/without a set-top box), cellular phones. However, the data may be displayed in a form in accordance with the display device chosen by the user. For example, both full-motion video and text story may be rendered simultaneously on a PC with a broadband connection, while a PDA may only display the text. The device capability profiles and different display choices may be expressed using various emerging standards, such as CC/PP and XSL from W3C.

According to one embodiment of the present invention, the data is not required to be integrated, and may be stored 695 and displayed 697 in a segregated form 698-699. This allows the user to watch the entire interview and/or read the entire website story separately, and even follow the hyperlinks in the article if the user chooses to do so.

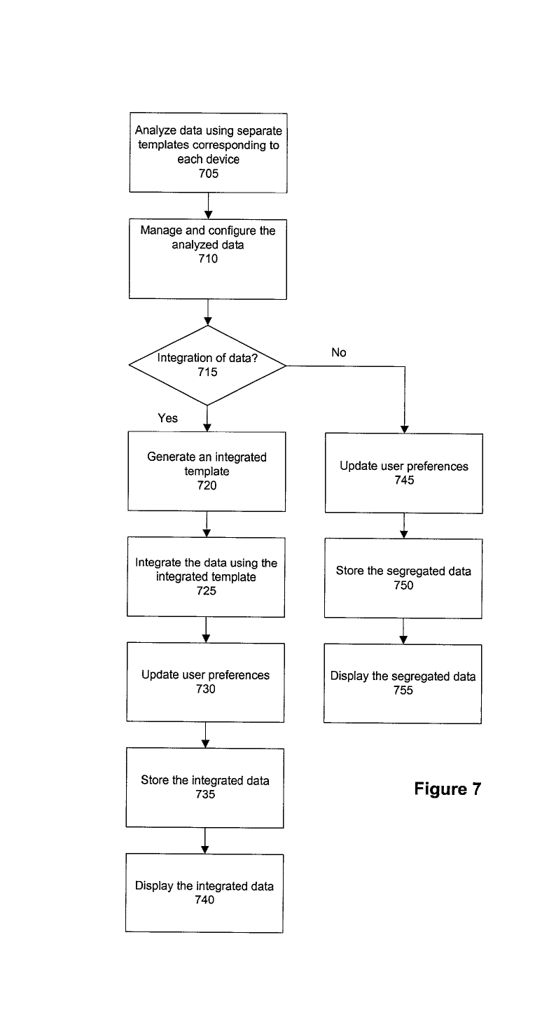

FIG. 7 is a flow diagram illustrating the process of personalizing and integrating user information in a media consumption system, according to one embodiment of the present invention. First, the data from multiple devices along with data manually entered, if any, by the user is analyzed using corresponding device templates in processing block 705. The outcome of the analysis (meta description) is then transferred to the data management and configuration module for further processing in processing block 710. At processing block 710, in the data management and configuration module, the data is parsed, configured, and translated into a common descriptor to be used for updating user preferences, storage for future use, display, and integration, if necessary.

At decision block 715, the user decides whether to integrate the data received from the management and configuration module. If the data is to be integrated, an integrated template is retrieved in processing block 720. The integrator then integrates the data using the integrated template by filtering, sorting and prioritizing the data having the common descriptor in processing block 725. The integrated data is used to update user preferences in processing block 730. Further, the integrated data is stored for future use in processing block 735. A user may choose to display the integrated data on a display device of the user's choice in processing block 740. If the data is not to be integrated, the segregated data is used to update user preferences in processing block 745. Further, the segregated data is also stored for future use in processing block 750. As with the integrated data, the user may choose to display the segregated data on a display device of his or her choice in processing block 755.

What is claimed is:

1. A method comprising:
identifying a user, wherein the user inserting a smart card into a device selected from a plurality of devices;
identifying the device;
identifying user preferences associated with the device;
tracking user pattern and gathering usage data;
analyzing the usage data;
configuring the analyzed data; and
updating the user preferences.

2. The method of claim 1 further comprising retrieving an identification template from a template database for the identifying the user and the identifying the device.

3. The method of claim 1 further comprising retrieving a user preference template corresponding to the device from a plurality of user preference templates corresponding to the plurality of devices from the template database for the identifying the user preferences and for the updating the user preferences by updating the corresponding user preferences template using the configured data.

4. The method of claim 1 further comprising retrieving a user history template corresponding to the device from a plurality of user history templates corresponding to the plurality of devices from the template database for the tracking the user pattern and the gathering the usage data.

5. The method of claim 1, wherein the tracking the user pattern is based on a predetermined criteria.

6. The method of claim 1, wherein the analyzing the usage data comprising analyzing text associated with a media program, wherein the text including closed caption information and articles.

7. The method of claim 1, wherein the analyzing the usage data comprising analyzing audio information associated with the media program, wherein the audio information including words, phrases, and audio expressions.

8. The method of claim 1, wherein the analyzing the usage data comprising analyzing video, wherein the video comprising sequence of motion associated with the media program.

9. The method of claim 1, wherein the plurality of devices comprising multiple types of media devices including a television, a computer, a PDA, a cellular phone, a portable media player, a web terminal, and a set-top box.

10. The method of claim 9 further comprising displaying the stored data using the plurality of devices, wherein the stored data is adjustable in accordance with display requirements of the plurality of devices.

11. The method of claim 1, wherein the updating the user preferences comprising dynamically updating the user preferences.

12. A method comprising:
identifying a user, wherein the user inserting a smart card into a plurality of devices;
identifying the plurality of devices;
identifying user preferences associated with the plurality of devices;
tracking user pattern and gathering usage data;
analyzing the usage data;
configuring the analyzed data;
integrating the configured data; and
updating the user preferences.

13. The method of claim 12, wherein the configuring the analyzed data further comprising:
parsing the analyzed data; and
associating the parsed data with a common descriptor, wherein the common descriptor is a word or a phrase descriptive of the content associated with the parsed data.

14. The method of claim 12 further comprising:
retrieving a plurality of user history templates corresponding to the plurality of devices;
generating an integrated user history template by integrating the plurality of corresponding user history templates for integrating the configured data; and
filtering the integrated data.

15. The method of claim 12 further comprising storing the integrated data.

16. The method of claim 15 further comprising displaying the stored data using a plurality of devices, wherein the stored data is adjustable in accordance with display requirements of the plurality of devices.

17. A system for updating user preferences for personalization media consumption from device to devices comprising:
an identification template retrieved from a template database for identifying a user, wherein the user inserting a smart card issued by an issuer into at least one of a plurality of devices;
the identification template for identifying the at least one of the plurality of devices;
a user preference template corresponding to the at least one of the plurality of devices from a plurality of user preference templates corresponding to the plurality of devices retrieved from the template database for identifying user preferences associated with the device;
a user history template corresponding to the at least one of the plurality of devices from a plurality of user history templates corresponding to the plurality of devices from the template database for tracking user pattern and gathering usage data;
an analyzer for analyzing the usage data, wherein the analyzer comprising a text analyzer for analyzing text associated with a media program, an audio analyzer for analyzing audio associated with the media program, and a video analyzer for analyzing sequence of motion associated with the media program;
a management and configuration module for configuring the analyzed data;
updating the user preferences; and
storing the configured data.

18. The system of claim 17 further comprising:
the management and configuration module for parsing the analyzed data;
the management and configuration module for associating the parsed data with a common descriptor, wherein the common descriptor is a word or a phrase descriptive of the content associated with the parsed data;
an integration module for filtering and integrating the configured data using an integrated user history templates;
updating the user preferences; and
storing the integrated data.

19. The system of claim 17, wherein the template database is associated with at least one of a plurality of sources including the smart card, the issuer, and the plurality of devices.

20. The system of claim 17, wherein the plurality of devices comprising multiple types of media devices including a television, a computer, a PDA, a cellular phone, a portable media player, a web terminal, and a set-top box.

21. A machine-readable medium having stored thereon data representing sequences of instructions, the sequences of instructions which, when executed by a processor, cause the processor to:
identify a user, wherein the user inserts a smart card into a device selected from a plurality of devices;
identify the device;
identify user preferences associated with the device;
track user pattern and gather usage data;
analyze the usage data;
configure the analyzed data; and
update the user preferences.

22. The machine-readable medium of claim 21, wherein the sequences of instructions further cause the processor to:
retrieve an identification template from a template database.

23. The machine-readable medium of claim 21, wherein the sequences of instructions further cause the processor to:
retrieve a user preference template corresponding to the device from a plurality of user preference templates corresponding to the plurality of devices from the template database.

24. The machine-readable medium of claim 21, wherein the sequences of instructions further cause the processor to:
retrieve a user history template corresponding to the device from a plurality of user history templates corresponding to the plurality of devices from the template database.

25. The machine-readable medium of claim 21, wherein the sequences of instructions further cause the processor to:
analyze text associated with a media program, wherein the text includes closed caption information and articles;
analyze audio associated with the media program, wherein the audio includes words, phrases, and audio expressions;
analyze video associated with the media program, wherein the video includes sequence of motion associated with the media program.

26. The machine-readable medium of claim 21, wherein the plurality of devices comprises multiple types of media devices including a television, a computer, a PDA, a cellular phone, a portable media player, a web terminal, and a set-top box.

27. The machine-readable medium of claim 21, wherein the update the user preferences comprises dynamically update the user preferences.

28. A machine-readable medium having stored thereon data representing sequences of instructions, the sequences of instructions which, when executed by a processor, cause the processor to:
identify a user, wherein the user inserting a smart card into a plurality of devices;
identify the plurality of devices;
identify user preferences associated with the plurality of devices;
track user pattern and gathering usage data;
analyze the usage data;
configure the analyzed data;
integrate the configured data; and
update the user preferences.

29. The machine-readable medium of claim 28, wherein the sequences of instructions further cause the processor to:
parse the analyzed data; and
associate the parsed data with a common descriptor, wherein the common descriptor is a word or a phrase descriptive of the content associated with the parsed data.

30. The machine-readable medium of claim 28, wherein the sequences of instructions further cause the processor to:
retrieve a plurality of user history templates corresponding to the plurality of devices;
generate an integrated user history template by integrating the plurality of corresponding user history templates; and
filter the integrated data.
